(19) United States
(12) Patent Application Publication
(10) Pub. No.: US 2008/0185290 A1
(43) Pub. Date: Aug. 7, 2008

(54) Recovery System of Dna and Rna or Protein Fragments with Agarose Gel or Polyacrylamide Gel

(76) Inventor: Jae Gyeong Jeong, Busan (KR)

Correspondence Address: SUGHRUE MION, PLLC, 2100 PENNSYLVANIA AVENUE, N.W., SUITE 800, WASHINGTON, DC, 20037, US

(21) Appl. No.: 11/997,177

(22) PCT Filed: Aug. 1, 2006
(86) PCT No.: PCT/KR06/03032

§ 371 Date: Jan. 29, 2008

(30) Foreign Application Priority Data
Aug. 1, 2005 (KR) 10-2005-0070430
Aug. 1, 2006 (KR) 10-2006-0072767

(51) Int. Cl. G01N 27/26; C25C 7/02

(52) U.S. Cl. 204/456; 204/606

(57) ABSTRACT

This is a device that directly collects DNA, RNA, or protein on agarose gel or polyacrylamide gel, which is separated and purified after applying electrophoresis to DNA, RNA, or protein on agarose gel or polyacrylamide gel. The present invention has improved the traditional methods that collect DNA, RNA, or protein fragments in the gel by slicing the gel in order to collect DNA, RNA, or protein fragments that are purified and separated by applying electrophoresis to DNA, RNA, or protein. The present invention offers a system that after applying electrophoresis to agarose gel or polyacrylamide gel, confirms the electrophoresed DNA, RNA, or protein fragments, and then collects DNA by sending DNA, RNA, or protein to the desired location through another electrophoresis, where the system has the integrated process of extracting DNA, RNA, or protein depending on the direction of the flow of electric charge or the reversed direction, and extracts DNA, RNA, or protein by utilizing the electrophoresis system different from the traditional one.

### TECHNICAL FIELD

Biotechnology, Molecular Biotechnology, Biotechnology Platform, Electric Chemistry, Electric Analysis Chemistry.

The present invention is about one of the techniques to be used to separate DNA, RNA, or protein fragments from agarose gel or polyacrylamide gel. The present invention introduces one of the various methods to collect DNA fragments, RNA fragments, or protein fragments that exist in the gel after applying electrophoresis to agarose gel or polyacrylamide gel (to be called gel here in after).

Electrophoresis is mostly applied to DNA or RNA in case of agarose gel, while it is mainly applied to protein in case of polyacrylamide gel though it is sporadically applied to DNA or RNA.

### BACKGROUND ART

DNA, RNA, or protein fragments in the gel should be usually cut to gel pieces after applying electrophoresis. In order to raise selectivity of desired fragments, they should be sliced following each band. A few methods are available to collect DNA, RNA, or protein from the sliced gel.

A commonly used method is to put the sliced gel into a dialysis tube, fill it with an appropriate buffer, and then apply electrophoresis in the electrophoresis tank again. Then fragments that were in the gel will come out, and contents inside the tube should be collected except gel. Desired fragments can be collected by separating collected buffer solution and fragments.

Or fragments should be bonded together by directly putting fine glass bid, magnetic substance, or resin, after dissolving the sliced gel by applying chemicals or heat. Then desired fragments can be collected from them by separating bonded glass bid, magnetic substance, or fine resin.

More diverse methods can be used to collect DNA or RNA fragments as compared with protein. Put a membrane into an injector cylinder and then put the sliced agarose gel into it. Push the injector piston with a proper amount of pressure to grind down the gel. Push the piston all the way to collect DNA stuck to the membrane.

Drop one or two drops of buffer solution on the sliced gel. Put the gel in between the cathode ray and the anode ray and transmit electric charge to the buffer solution and the gel by applying electricity. Then DNA in the gel will be pushed into the buffer solution. In this way, DNA contained in the buffer solution can be extracted.

Make holes on both sides of the lidded plastic tube and put a membrane over there. Put the sliced gel into the tube and put the membrane and the gel in alignment after closing the lid. Put the tube into the electrophoresis tank and transmit electric charge to where the membrane on both sides is placed so that DNA, RNA, or protein in the gel can be extracted. Reverse the tube when DNA, RNA, or protein in the gel is about to be extracted after certain amount of time elapses, so that DNA, RNA, or protein may move to the opposite direction from the flow of electric charge before being extracted from the membrane. Then take the buffer in the tube and collect fragments in it.

Diverse techniques are available as stated above and the most universal technique is using a filter column. Put a piece of filter paper containing a glass element in a column. Slice the gel, dissolve it with chemicals, and then permeate the dissolved solution into the filter column. Let fragments be combined with the glass element in the filter paper so that DNA can be extracted by washing them. A popular way of extracting protein is the method using resin only. This kind of method is the most universally used one, and specific techniques about this particular method are in the process of making rapid progress to become a significant axis in the bioscience industry.

### DISCLOSURE OF INVENTION

### Technical Problem

The ultimate goal of the bioscience industry is the extension of quality life. A variety of fields and forms have been developed to achieve the goal. Among them, molecular biology is taking very slow steps in the presence of a lot of easily imaginable tasks. Researches ranging from the DNA field to the protein field, including discovery of the most fundamental DNA, a little more advanced RNA, and protein close to a destination, have been underway sequentially and concurrently.

Such research projects usually are comprised of differently fragmented works. They normally take different routes, but a few of them can form a combination on demand to complete a short segment of the project. These works are mostly done by hand, and require well-educated individuals in view of the nature of work. For these reasons, the pace of research progress is inevitably slower than what scientists wish to see. As far as scientists are concerned, it would be very ideal for the pace to be maintained as fast as their brain speed. Such necessity called for a technology called automation, and automation was prominently used for the analysis of base order in the DNA research.

However, phases prior to the analysis of base order are still comprised of fragmentary works.

Taking notice of the problem, the present technology came up with a technical solution for automation, and will pave the way for time saving, high reproducibility, and technical clue for the future automation.

### Technical Solution

In the present invention, after electrophoresis is applied to agarose gel and poly-acrylamide gel, thin films (11) as wide as DNA, RNA, or protein fragments are arranged on the gel at narrow intervals. Make slits (12) on thin films, fill them with buffer or electrolyte, and connect electrodes for electrophoresis (21)(+,−) on the upper parts of buffer or electrolyte. Though the positive electrode is usually connected, the negative electrode can be connected depending on the charge of fragments to be collected. Here is a chart showing what can be done with the electrophoresis tank's lid (chart 2, chart 3) connected to electrodes (21). The electrode (chart 2) connected to the lid (chart 2, chart 3) is submerged with buffer or electrolyte via slits. Once electrophoresis is completed on the gel (14), DNA, RNA, or protein fragments are flowed into buffer or electrolyte in the slit (12) by intercepting the power supply (31,32) in the direction of fragments and diverting (chart 2b) it to the electrode (21) connected to the lid. Then DNA, RNA, or protein fragments can be collected by gathering buffer or electrolyte.

The slit (12) has a hole on its lower part (14), and its lower part here refers to the upper part of agarose gel in touch with the slit or one side (93) of polyacrylamide gel.

The slit (12) is comprised of a piece of thin film (chart 7), and extracting DNA, RNA, or protein requires more than one side like thin film (chart 7). Buffer or electrolyte is supplied to the other side, and power supply for electrophoresis (62) is applied to the supplied buffer or electrolyte.

A slit or one side of thin film is placed on the upper part of the gel or inside the gel, and DNA, RNA, or protein fragments should be gathered within the slit by confining the starting point or the finishing point of electric charge within the slit for slits consisting of slit, one slit, or more than one slit. That's why this method is different from the traditional method that could collect DNA, RNA, or protein fragments only by slicing the gel.

There are a few known methods for collecting protein from agarose gel, DNA, and polyacrylamide. The common point of these methods is to have to slice the gel after electrophoresis and stop electrophoresis for slicing.

The structure of the present invention can be easily understood if eight experiments conducted for the same goal are sequentially studied. The following experiment conditions are given under the situation of applying general electrophoresis for separation of DNA, RNA, or protein and confirmation process. The following conditions are based on the horizontal case. The same conditions apply to the vertical case, where same results can be obtained with a positional change from horizontal to vertical.

First, when electrophoresis is applied to agarose gel or polyacrylamide gel (chart 5), fragments generally flow from negative electrode (41) to positive electrode (42). As for the gel plate (43), make a well (44) in the direction of fragments and fill the well (44) with buffer. When electrophoresis is applied, fragments (45) of all sorts rapidly cross over (48) to the other side of the well as soon as they reach the well. Even if fluorescent material or dyes are applied to the fragments for radiation, the scene of crossing over (48) the well cannot be directly observed with the naked eye. At this point of time, it can be observed (48) that fragments (47) surrounding the well disappear from the negative electrode and then appear in the direction of the positive electrode. If the current is intercepted and the buffer in the well (49) is collected at that moment, all sorts of fragments can be extracted with a very small amount.

Efficiency can be dramatically enhanced if the material that can absorb DNA, RNA, or protein fragments, namely, fine glass bid, magnetic substance, or resin is put into buffer or electrolyte and then they are taken out together.

Second, if nonconducting material is connected with the gel (53) in between the negative power supply (51) and the positive power supply (52) when electrophoresis is applied to agarose gel or polyacrylamide gel, then a shadow (54) segment incapable of electrophoresis as wide as the nonconductor is formed. But if a conductor (53) allowing a free flow of electricity is connected instead of a nonconductor, electrophoresis (57) can take place in the direction of the negative electrode from the conductor. If electrophoresis is applied until fragments reach the positive power supply, a shadow (57) is formed in the positive power supply from the conductor.

Third, by combining a conductor and a nonconductor as experimented in the second item, a thin film (65) was formed in such a way that the conductor (62) is connected to the positive electrode while the nonconductor (61) is connected to the negative electrode. The conductor (63) was set up to be overlapped with the upper part (66) of the nonconductor (65) and cover it to the certain height of the upper part of the non-conductor. Let us call it “double thin film” for its arbitrary name. After applying electrophoresis for the gel, connect “double thin film” (chart 7, chart 8) to the positive electrode direction of fragments to be collected, namely the positive direction of the edge of the fragments band. When “double thin film” is connected to the gel plate, a conductor should face the positive electrode direction while a nonconductor should face the negative electrode direction, and the gel should not be in touch with the conductor (62) on the upper part of the nonconductor of this “double thin film.” Electrolyte or buffer is dropped in the direction of the nonconductor of this “double thin film”, namely the negative electrode direction. At this point of time, electrolyte or buffer solution should not be allowed to spread out but stay on the band to be extracted. The flow of electric charge starts from the positive electrode and then goes through the conductor of “double thin film,” the conductor (62) on the upper part of the nonconductor of this “double thin film,” and electrolyte or buffer until it reaches fragments. Fragments proceed in the opposite direction to the flow of electric charge before they are stopped by electrolyte or buffer solution. Plus, all sorts of fragments can be simply collected if buffer is pipetted. Fragments on the gel could be collected with such an experiment.

Fourth, another experiment method is to make “double thin film” differently. A thin film made from nonconductor (73) is added to the side of “double thin film” in touch with buffer solution or electrolyte so that buffer solution or electrolyte may not spread out for secure confinement (chart 10, chart 11). “Double thin film” made this way is also called “double thin film well”, and the space in between the nonconductor thin film and “double thin film” is also called “slit”, which is sometimes called “well.” When electrophoresis is finished, adjust “slit” up to the upper part (74) of the fragments band to be collected. Connect “double thin film well” (chart 10, chart 11) to the gel and then put buffer solution or electrolyte into the “well” before applying electrophoresis again. In this way, DNA or RNA fragments can be collected from electrolyte or buffer solution in the “slit.”

If the lower part of “double thin film” of “double thin film well” is cut out instead of connecting it to the gel, then the result is as shown in (chart 12). Remove only the conductor part of the positive electrode and directly connect the positive power supply to the upper part. Intercept the positive power supply for electrophoresis and provide an electric current to the positive power supply connected to the negative power supply for electrophoresis and the upper part of “double thin film well.” Then DNA, RNA, or protein fragments can be collected from the “slit” along with buffer solution or electrolyte solution.

Fifth, make “double thin film well” having a different position of the conductor as shown in chart 15. Build a bridge (101) in the lower part and a partition (101) like a curtain on the bridge. Put “double thin film well” (chart 16) on the lane of sample to be separated during electrophoresis.

Stop electrophoresis in progress when fragments to be extracted from the gel are confirmed to be right under the slit, and provide power to the power supply of the conductor connection part and the interrelated power supply. Then fragments that were flowing from the negative (111) direction which is the direction of an arbitrary x-axis (113) to the positive (112) direction, will concurrently move toward the direction of an arbitrary y-axis (114) and an arbitrary z-axis (115). Here y-axis (114) means the perpendicular direction from the horizontal plane of x-axis (113), and z-axis (115) means the perpendicular direction from the plane of x-axis and y-axis. Fragments that moved are to be contained in buffer solution or electrolyte of the slit or the well.

Here in case of “double thin film well”, the lower part (116) of y-axis direction has come down farther than the lower part (117) of x-axis direction. As a result, when electrophoresis is applied with multiple lanes, adjacent lane's fragments are prevented from mixing. The height (92) from the well floor of the gel to the floor of the gel should be higher than the height of the lower part of y-axis of “double thin film well.”

Sixth, the experiment result as above shows that DNA, RNA, or protein fragments can be partially collected through electrophoresis. When electrophoresis is applied with multiple lanes, it is necessary to have a device that can collect fragments of multiple bands. So their “double thin film wells” should be laid one upon another horizontally and vertically. Make a direct connection between the thin film well's conductor and the positive power supply, or completely remove the conductor from “double thin film well” and directly soak the “pin” of the positive electrode in buffer solution or electrolyte. When agarose gel or polyacrylamide gel is made, the position of the well (94) in the gel should be in the direction of x-axis (95) aligned with the thin film well, namely the slit, and the floor height (94) of the well (94) in the gel, namely the floor position of the well (92) in the gel should be higher than the height of the lower part of the y-axis (102) direction of the lower part of “double thin film well.” This method will remove a possibility that adjacent lane's fragments accidentally get mixed up when fragments are extracted. Extract fragments by putting buffer solution or electrolyte in the slit, and applying a positive electric current of the slit and a negative electric current on the same axis line.

Seventh, when fragments are about to be collected after applying electrophoresis, place “double thin film well” in an overlapped form (chart 17) on agarose gel (chart 13) or polyacrylamide gel (93). The then “double thin film well” should have a conductor inside the positive electrode. “Double thin film well” is made in the state like chart 12, where its lower part is cut out as much as being connected instead of connecting it to the gel as shown in the fourth experiment.

Leave the negative electric current while turning off the positive electric current after applying electrophoresis on the arbitrary x-axis line. Supply power with the conductor of “double thin film well”, and apply the negative electric current for electrophoresis and the positive electric current for the conductor of “double thin film well.” After time necessary for fragments to gather in the slit elapses, switch off power supply and collect buffer or electrolyte in the slit to collect fragments there.

The final method begins with making agarose or polyacrylamide gel plate as shown in (chart 18). “Double thin film well” is comprised of a conductor (131) and a non-conductor (132) as shown in chart 19 and chart 20. When it is about to be placed on the gel plate to convert agarose or polyacrylamide to gel, place it on the solidified get plate after slicing the gel. Use a nonconductor as a slit. When “double thin film well” is placed in the gel to solidify the gel, be sure that liquefied gel must not flow in between the slits. After checking separation of fragments after applying electrophoresis and filling the slits with buffer or electrolyte, let the flow of electric charge proceed from the slits (132) side to the fragments (133) side to send DNA, RNA, or protein fragments (133) to be collected toward the slits (132) side. In this way, DNA, RNA, or protein fragments (133) are collected in the slit (134).

In case that there are multiple lanes needing electrophoresis, put multiple pins between lanes and then apply electrophoresis sequentially as above.

### ADVANTAGEOUS EFFECTS

The invention stated above has integrated what used to be done separately for extraction after confirmation of RNA, DNA, or protein fragments, a step next to the traditional electrophoresis work, and thus allowed time saving and one continuous work replacing multiphase manual work without interconnection. It has also added new processes for quantization and purification to electrophoresis process, which didn't have any more functions than separation and confirmation.

Electrophoresis technique has not been able to play its full role because there was no way to collect what was electrolyzed despite it is certainly a part of electrolysis, but has made a new epoch to directly extract DNA, RNA, and even protein from tissues, cells, blood of animals and plants by facilitating collection.

It will be a foundational technology capable of automating manual works by especially enhancing reproducibility of work, and will become one of the useful inventions in the bioscience field.

### BRIEF DESCRIPTION OF THE DRAWINGS

Chart 1 shows a gel plate, the present invention.

Chart 2 shows provision of power supply to the gel plate.

Chart 3 shows the rear part of the electrode providing power supply to the gel plate, where the electric circuit on the back side is separated from the electrode.

Chart 4 shows a gel plate, the present invention.

Chart 5 shows, in case that a well is present, the fragments' sequential order of crossing over the well.

Chart 6 shows arrangement of a conductor and a nonconductor when electrophoresis is applied.

Chart 7 & 8 show the most basic form of fragments-collecting device in the present invention and its operating principle.

Chart 9 & 10 & 11 show the device that collects fragments more effectively than chart 7 & 8.

Chart 12 shows the device that collects more effectively than chart 9 & 10 & 11.

Chart 13 & 14 explain the gap between the gel surface and the well, and the x-axis direction.

Chart 15 shows the principle of not being polluted by the adjacent lane when a great quantity of fragments are concurrently collected.

Chart 16 briefly shows the device that concurrently collects a great quantity of fragments without being polluted by the adjacent lane.

Chart 17 shows the device that concurrently collects a great quantity of fragments from the same sample regardless of the sizes of the fragments.

Chart 18 & 19 & 20 show the device that helps produce a great quantity of collecting devices easily for use.

### EXPLANATION OF SYMBOLS CONCERNING THE MAJOR PART OF CHART

11: thin film 12: slit 13: gel cast and gel plate 14: gel
16: well into which experiment objects such as DNA, RNA, protein, and tissues to be purified and collected are to be put
31,32,41,42,51,52,71,72,81,111,112: electrode or wire for power supply
44: well containing buffer or electrolyte
45: DNA, RNA, or protein fragments
53: nonconductor
55: conductor
62,63,66: plate comprising conductor
65: thin plate made from nonconductor
53: nonconductor
55: conductor
62,63,66: plate comprising conductor
65: thin plate made from nonconductor
74: thin film well comprising twofold plates with conductor and nonconductor in parts
92: thickness between the well into which experiment objects are to be put and the outer wall of the gel
103: explanation on the requirement that should be thinner than the thickness of 92 in order not to be polluted by the adjacent lane
113,114,115: theoretical explanation on details concerning sections of electrophoresis for x-, y-, and z-axis

### BEST MODE FOR CARRYING OUT THE INVENTION

To maximize the invention's effect, it would be the best form to separate the gel from the collecting device, and by independently performing the confirmation process and the collection process after the separation, the user's convenience would be attained with an introduction of new technology without having to break away from existing processes.

### MODE FOR THE INVENTION

As the gel cast in which the gel of chart 1 is laid, chart 2a, the lid portion, becomes the lower side while chart 2b becomes the upper side. Their combination enables separation, purification, and collection.

### INDUSTRIAL APPLICABILITY

Most experiments conducted in bio-genetic engineering laboratories are usually first-phase experiments requiring a lot of manual work. The present invention will be a great help for these experiments, and will make a substantial contribution for the progress of life science by becoming a technical background to automate the manual work.

1. Fragments flow along in the x-axis direction of the flow of electric current over the agarose gel. Making a well in the x-axis direction to which the fragments will move, and collecting fragments in the well by using fragments absorbent, and a method to collect buffer solution or electrolyte, and a method to proceed to another process by using the remaining fragments in the well.

2. Fragments flow along in the x-axis direction of the flow of electric current over the polyacrylamide gel. Making a well in the x-axis direction to which the fragments will move, and collecting fragments in the well by using fragments absorbent, and a method to collect buffer solution or electrolyte, and a device to help proceed to next process by using the remaining fragments in the well.

3. Fragments flow along in the x-axis direction of the flow of electric current over the 2-dimensional polyacrylamide gel, and also flow along when electric current flows in the y-axis direction again. Making a well in the y-axis direction to which the fragments will move, and collecting fragments in the well by using fragments absorbent, and a method to collect buffer solution or electrolyte, and a device to help proceed to next process by using the remaining fragments in the well.

4. Moving fragments vertically to the collecting device by switching off the flow of electric current from the x-axis on the horizontal plane where electric current flows over the agarose gel and applying electric current in the z-axis direction on the vertical plane, and moving fragments vertically by applying electric current in the z-axis direction for collection, and a device to help proceed to next process from the collecting device by moving them in the z-axis direction rather than attempting to collect.

5. Moving fragments vertically to the collecting device by switching off the flow of electric current from the x-axis on the horizontal plane where electric current flows over the polyacrylamide gel and applying electric current in the z-axis direction on the vertical plane, and moving fragments vertically by applying electric current in the z-axis direction for collection, and a device to help proceed to next process from the collecting device by moving them in the z-axis direction rather than attempting to collect.

6. Moving fragments vertically to the collecting device by switching off both the flow of electric current from the x-axis on the horizontal plane and the flow of electric current from the y-axis on the horizontal plane where electric current flows over the 2-dimensional polyacrylamide gel, and applying electric current in the z-axis direction on the vertical plane perpendicular to two lines, and moving fragments vertically by applying electric current in the z-axis direction for collection, and a device to help proceed to next process from the collecting device by moving them in the z-axis direction rather than attempting to collect.

7. Moving fragments to the collecting device by applying the flow of electric current to the summed direction of the x-axis on the horizontal plane where electric current flows over the agarose gel and the z-axis perpendicular to the x-axis, and moving fragments to the collecting device by applying the flow of electric current to the summed direction of the y-axis on the horizontal plane like the x-axis and the z-axis perpendicular to the y-axis, and moving fragments to the collecting device by applying the flow of electric current to the summed direction of the horizontal plane and the z-axis after applying electricity in the directions of certain starting point on the plane formed by the x-axis and the y-axis and the z-axis, and moving fragments for collection, and a device to help proceed to next process from the collecting device rather than attempting to collect.

8. Moving fragments to the collecting device by applying the flow of electric current to the summed direction of the x-axis on the horizontal plane where electric current flows over the polyacrylamide gel and the z-axis perpendicular to the x-axis, and moving fragments to the collecting device by applying the flow of electric current to the summed direction of the y-axis on the horizontal plane like the x-axis and the z-axis perpendicular to the y-axis, and moving fragments to the collecting device by applying the flow of electric current to the summed direction of the horizontal plane and the z-axis after applying electricity in the directions of certain starting point on the plane formed by the x-axis and the y-axis and the z-axis, and moving fragments for collection, and a device to help proceed to next process from the collecting device rather than attempting to collect.

9. Forming a plane with the x-axis direction where the first electric current flows over the 2-dimensional polyacrylamide gel and the y-axis direction where the second electric current flows, the z-axis would be set perpendicularly to the other two. Moving fragments to the collecting device by applying the flow of electric current to the summed direction of the horizontal plane and the z-axis after applying electricity in the directions of certain starting point on the plane, and moving fragments for collection, and a device to help proceed to next process from the collecting device rather than attempting to collect.

10. Moving fragments to the collecting device by diverting the flow of electric current from the x-axis where electrophoresis was being applied to the agarose gel to the direction of the y-axis on the horizontal plane, and moving fragments by applying electric current in the y-axis direction for collection, and a device to help proceed to next process from the collecting device by moving them in the y-axis direction rather than attempting to collect.

11. Moving fragments to the collecting device by diverting the flow of electric current from the x-axis where electrophoresis was being applied to the poly-acrylamide gel to the direction of the y-axis on the horizontal plane, and moving fragments by applying electric current in the y-axis direction for collection, and a device to help proceed to next process from the collecting device by moving them in the y-axis direction rather than attempting to collect.

12. Moving fragments to the collecting device by applying electric current toward the collecting device for the fragments separated by applying electrophoresis to the 2-dimensional polyacrylamide gel, and moving fragments for collection, and a device to help proceed to next process from the collecting device rather than attempting to collect.

13. Electrode that can flow electric current to the container holding buffer or electrolyte solution to collect fragments or the slit, and the electrode, submersible in buffer or electrolyte solution, whose length should be over 0.01 mm but below 90 mm, and the electrode, submersible in buffer or electrolyte solution, whose width should be over 0.01 mm but below 90 mm.

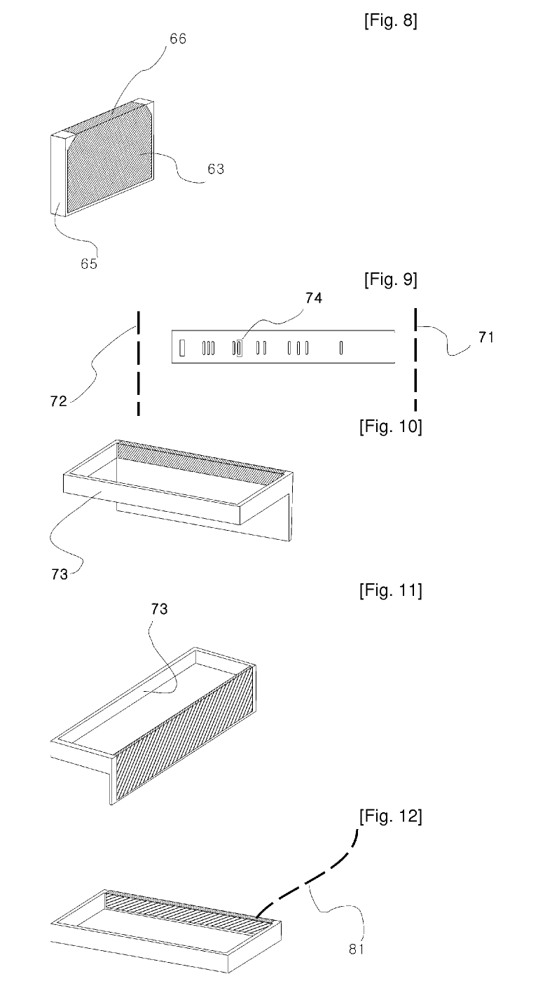

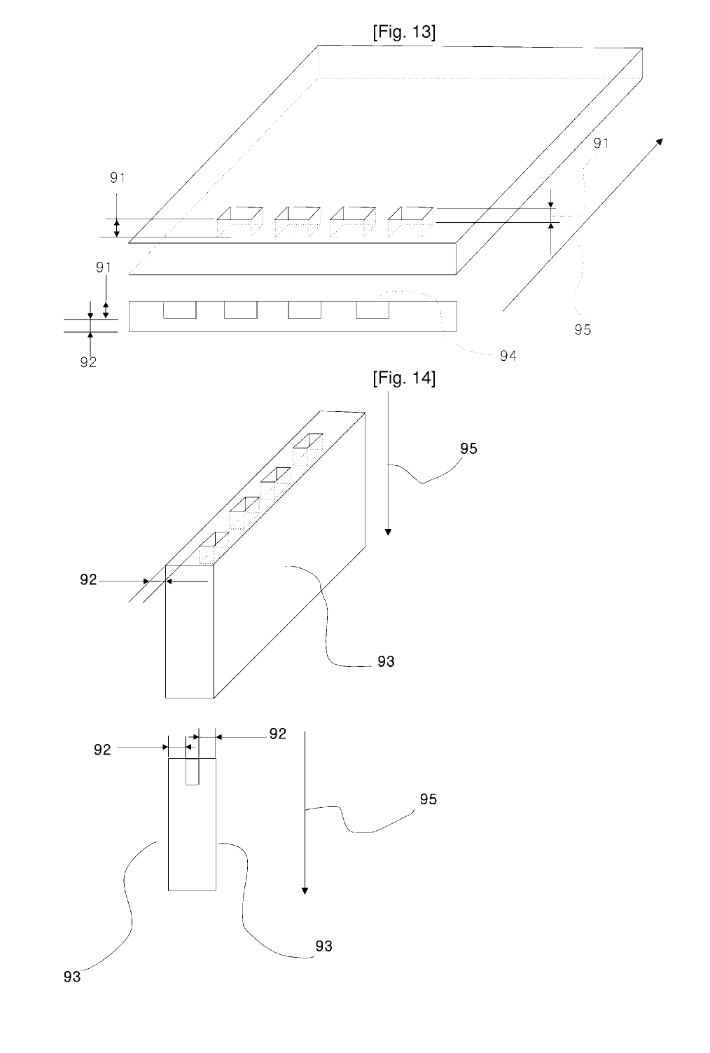

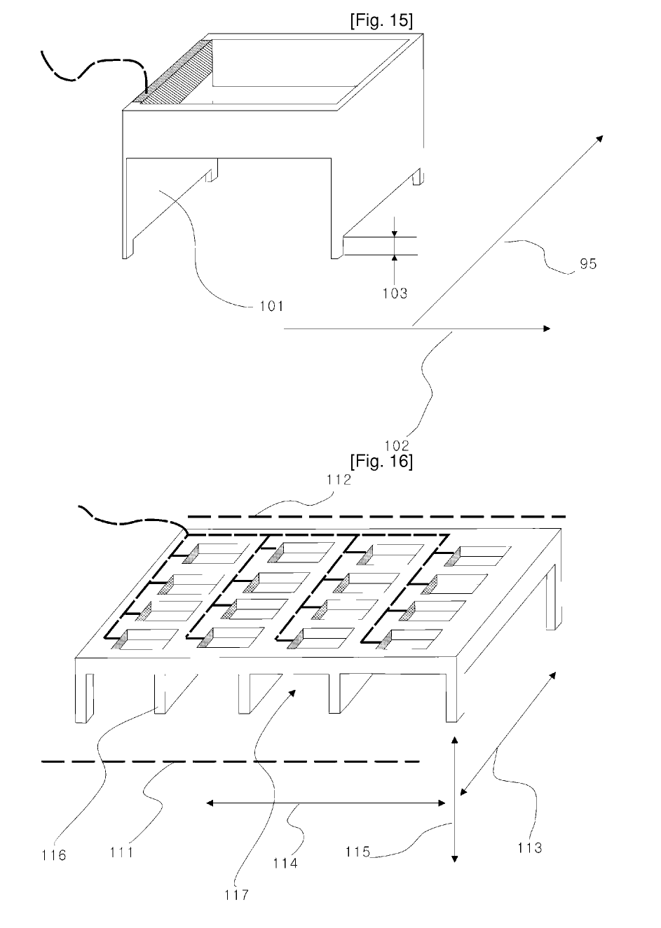

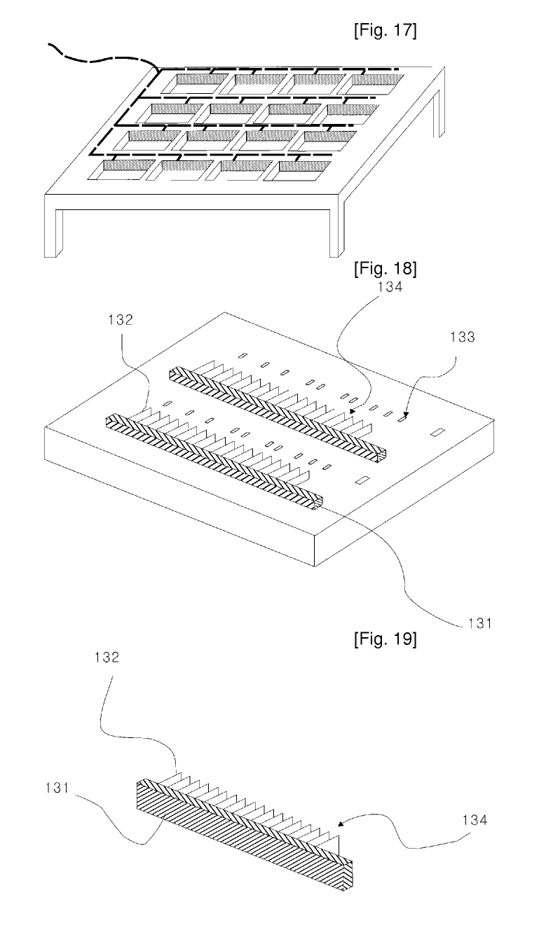

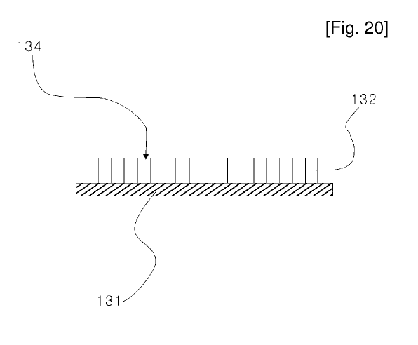

14. Container holding buffer or electrolyte solution to collect fragments or slit, where conductor is partially coated as shown in FIG. 7 and FIG. 8.

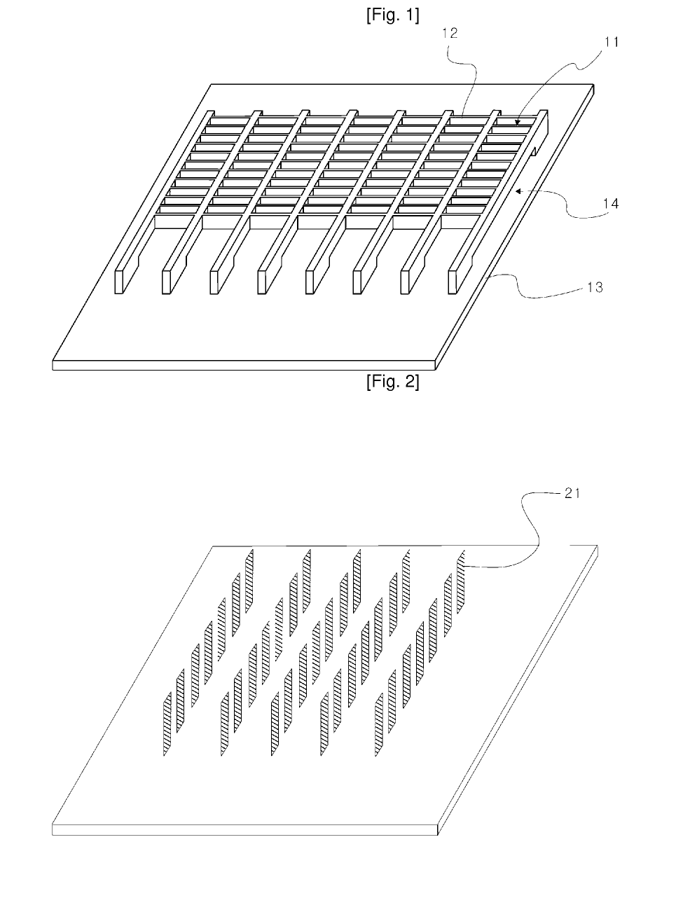

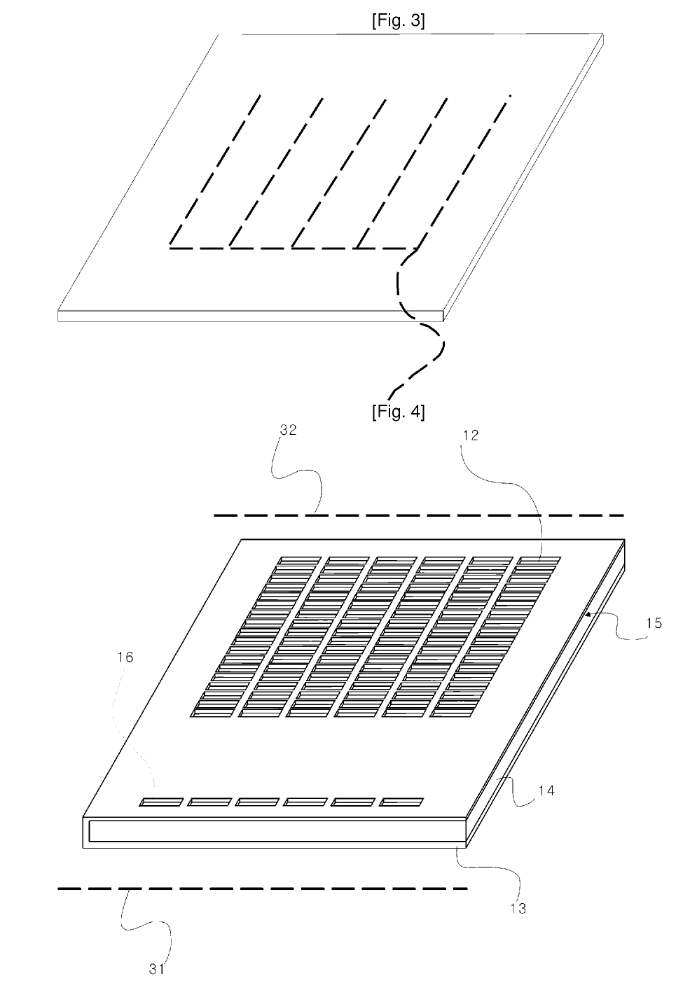

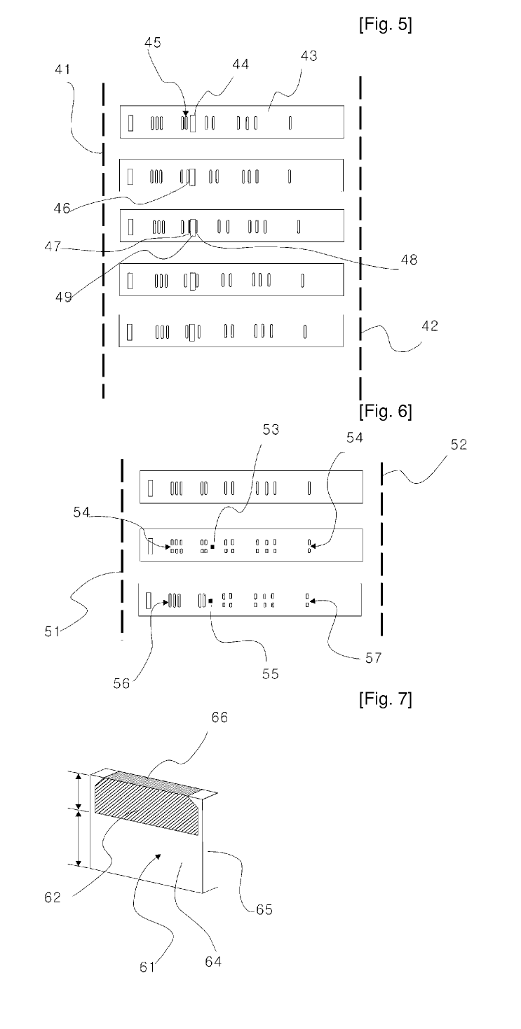

15. Container holding buffer or electrolyte solution to collect fragments or slit, where thin film is partially coated as shown in FIG. 5.

16. Container holding buffer or electrolyte solution to collect fragments using electrophoresis device or slit, where their wall width should be over 0.01 mm but below 40 mm.

17. Distance (84) between the well floor and the bottom of the gel for the collecting device and the length (85)(68) from the bottom of the lower part of the y-axis to the bottom of the gel for the collecting device should be short.

18. As for the collecting device, it is necessary to have a slit whose length (79) is over 0.4 mm but below 40 mm, and whose length (79) is over one fifth of the length of the well (80) but below forty times as long, and whose width is over one tenth of the width of the well but below ten times as wide.

19. Electrophoresis tank capable of diverting the direction of the flow of <−><+> electric current from the x-axis that was initially set for electrophoresis in the agarose electrophoresis tank to the direction of the y-axis corresponding to the x-axis.

20. Device in the electrophoresis tank capable of diverting the direction of the flow of <−><+> electric current from the x-axis direction or the y-axis direction to the z-axis direction.

21. As for the electrophoresis tank, it is necessary for the part where gel or gel plate is placed to be made from transparent material so that the light can penetrate it, and for the rest part to have black color or its likeness so that the light can be partially absorbed.
